(19) United States
(12) Patent Application Publication
(10) Pub. No.: US 2007/0213974 A1
(43) Pub. Date: Sep. 13, 2007

(54) Syntax analysis program, syntax analysis method, syntax analysis device, and computer-readable medium storing syntax analysis program

(75) Inventor: Guowei Xu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/490,219

(22) Filed: Jul. 21, 2006

(30) Foreign Application Priority Data
Mar. 9, 2006 (JP) 2006-064803

(51) Int. Cl. G06F 17/27

(52) U.S. Cl. 704/9

(57) ABSTRACT

A syntax analysis program includes an input step for inputting a sentence of a natural language, an analysis step for executing a morphological analysis and a syntax analysis with respect to the input sentence inputted in the input step, an extraction step for extracting the most similar analyzed corpus to the input sentence from an analyzed corpus database, a similarity calculation step for calculating the similarity between each analysis candidate and the extracted analyzed corpus when a plurality of analysis candidates are acquired in the analysis step, and an output step for outputting the analysis candidate with the maximum similarity as an analysis result when a plurality of analysis candidates are acquired in the analysis step or for outputting the analysis result acquired in the analysis step when only one analysis result is acquired in the analysis step.

### BACKGROUND OF THE INVENTION

The present invention relates to a syntax analysis program for analyzing syntax of natural language by a computer, a syntax analysis method, a syntax analysis device, and a computer readable medium in which the syntax analysis program is recorded. More particularly, the present invention relates to the program that is suitable for a syntax analysis of isolated language such as Chinese that is difficult to distinguish a delimitation between words.

This kind of syntax analysis device has been used in a machine translation system to analyze a grammatical structure of inputted natural language as a step prior to a translation, for example. When a user browses a website on the Internet that is described in foreign language, the translation to the native language by a machine translation is helpful. The machine translation system translates an original text by means of a morphological analysis and a syntax analysis to output a translated text.

Such a syntax analysis device is known as a prior art. For example, JP06-332940A discloses a syntax analysis device that analyzes an input sentence uniquely by the morphological analysis and the syntax analysis, calculates likelihoods of a plurality of analyzed input structures based on an example database and a thesaurus, and outputs the input structure with the maximum likelihood as an analysis result. Further, JP2003-196274A discloses a syntax analysis method that specifies a syntax structure of an input sentence. In the method, the sentence described in one language (Japanese, for example) and the corresponding translation described in another language (English, for example) are inputted. If a plurality of analysis results are generated from the sentence of one language and a system cannot determine which syntax structure is correct, the system specifies one of the analysis results based on syntax analysis information that is acquired by analyzing the corresponding translation of the sentence.

The device of JP06-332940A is effective to a language in which uniquely morphological analysis is possible. For example it is effective to a language such as English and Germans in which words are separated by spaces. It is also effective to a language such as Japanese in which words are divided by particles. However, the device is not effective to an isolated language like Chinese in which delimitations between words cannot be distinguished easily. That is, the analysis accuracy becomes lower. Since the method of JP2003-196274A needs not only the function to analyze the syntax of an input sentence but also the database of syntax analysis in a plurality of languages, the cost of the analysis device becomes higher.

### SUMMARY OF THE INVENTION

It is therefore an object of the present invention to provide an improved syntax analysis program (or a method, a device, a computer readable medium) which is capable of analyzing syntax of an isolated language like Chinese in high accuracy without using a corresponding translation of an original text.

A syntax analysis program of the present invention makes a computer execute steps including an input step for inputting a sentence of a natural language, an analysis step for executing a morphological analysis and a syntax analysis with respect to the input sentence inputted in the input step, an extraction step for extracting the most similar analyzed corpus to the input sentence from an analyzed corpus database, a similarity calculation step for calculating the similarity between each analysis candidate and the extracted analyzed corpus when a plurality of analysis candidates are acquired in the analysis step, and an output step for outputting the analysis candidate with the maximum similarity as an analysis result when a plurality of analysis candidates are acquired in the analysis step or for outputting the analysis result acquired in the analysis step when only one analysis result is acquired in the analysis step.

It is preferable that the analysis step has a function to presume an unregistered word contained in an input sentence based on the knowledge about the natural language to be used.

Further, in the similarity calculation step, the similarity between an analytical candidate and an analyzed corpus can be calculated using the contents of the morphemes analyzed by the morphological analysis and the syntax structure analyzed by the syntax analysis. Specifically, in the similarity calculation step, the similarity S can be calculated by the following equation.
S=(W₁/W) ·W₂

In this equation, W denotes the number of morphemes in the analysis candidate, W₁denotes the number of morphemes that have the same structure as morphemes of the extracted analyzed corpus, and W₂ denotes the number of morphemes that have the same structure and notation as morphemes of the extracted analyzed corpus.

In the similarity calculation step, the similarity between the contents of the morphemes analyzed by the morphological analysis and the contents of the morpheme of the analyzed corpus may be calculated as a correlation value between the concepts by a thesaurus. This analysis method is based on a general principle that the high similarity of the meanings of words in a sentence will result in the high similarity of the structure of the whole sentence.

On the other hand, the syntax analysis method of the present invention, which analyzes syntax with a programmed computer, includes the above-mentioned input step, the analysis step, the extraction step, the similarity calculation step, and the output step.

Further, a syntax analysis device of the present invention, which analyzes a syntax with a programmed computer, includes an input section for inputting a sentence of a natural language, an analysis section for executing a morphological analysis and a syntax analysis with respect to the input sentence inputted in the input section, an extraction section for extracting the most similar analyzed corpus to the input sentence from an analyzed corpus database, a similarity calculation section for calculating the similarity between each analysis candidate and the extracted analyzed corpus when a plurality of analysis candidates are acquired by the analysis section, and an output section for outputting the analysis candidate with the maximum similarity as an analysis result when a plurality of analysis candidates are acquired by the analysis section or for outputting the analysis result acquired by the analysis section when only one analysis result is acquired by the analysis section.

Still further, a computer-readable medium of the present invention stores a syntax analysis program that makes a computer execute the above-mentioned input step, the analysis step, the extraction step, the similarity calculation step, and the output step.

According to the syntax analysis program (a method, a device, a medium) of the present invention as mentioned above, the use of the analyzed corpus increases the accuracy of the syntax analysis by fixing errors in the syntax analysis due to delimitation errors in ambiguous compound nouns or unknown words of an isolated language like Chinese.

### DESCRIPTION OF THE ACCOMPANYING DRAWINGS

FIG. 1 is a block diagram showing outline of a syntax analysis device according to an embodiment of a the present invention,

FIG. 2 shows a syntax structure of an analysis candidate 1 outputted by the analysis section of the device shown in FIG. 1,

FIG. 3 shows a syntax structure of an analysis candidate 2 outputted by the analysis section of the device shown in FIG. 1,

FIG. 4 shows a syntax structure of an analyzed corpus extracted by the extraction section of the device shown in FIG. 1,

FIG. 5 shows a syntax structure of an analysis candidate 1 outputted by the analysis section of the device shown in FIG. 1,

FIG. 6 shows a syntax structure of an analysis candidate 2 outputted by the analysis section of the device shown in FIG. 1,

FIG. 7 shows the syntax structure of an analyzed corpus extracted by the extraction section of the device shown in FIG. 1, and

FIG. 8 shows a structure of a thesaurus used by the similarity calculation section of the device shown in FIG. 1.

### DESCRIPTION OF THE PREFERRED EMBODIMENTS

Hereafter, the embodiment of the syntax analysis device according to the present invention will be described with reference to drawings. Although Chinese is used as an isolated language of an analysis target in the embodiment, the present invention is also applicable to other isolated languages.

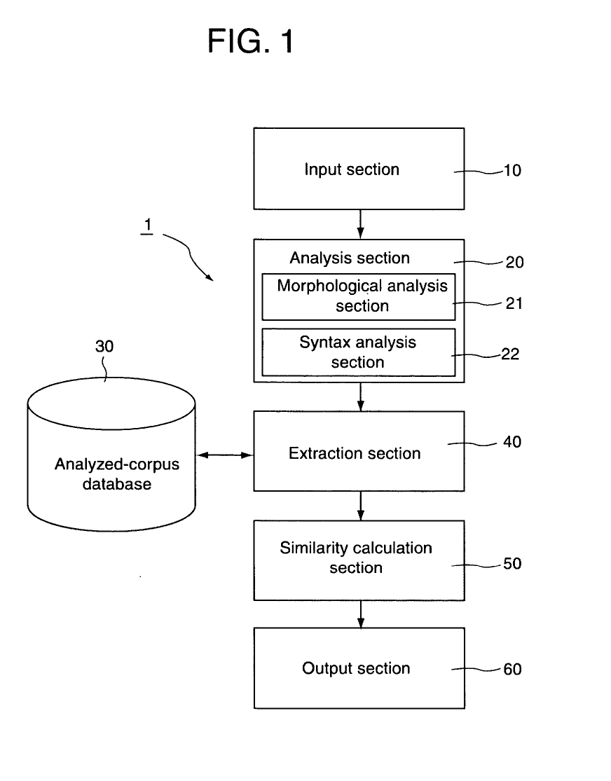

First, the outline of a syntax analysis device in which a syntax analysis program of the embodiment is installed will be described with reference to FIG. 1. As shown in FIG. 1, the syntax analysis device 1 is provided with an input section 10 for inputting a sentence of natural language, an analysis section 20 for executing a morphological analysis and a syntax analysis with respect to the input sentence inputted in the input section 10, an extraction section 40 for extracting the most similar analyzed corpus to the input sentence from an analyzed-corpus database 30, a similarity calculation section 50 for calculating the similarity between each analysis candidate and the extracted analyzed corpus when a plurality of analysis candidates are acquired by the analysis section 20, and an output section 60 for outputting the analysis candidate with the maximum similarity as an analysis result when a plurality of analysis candidates are acquired by the analysis section 20 or for outputting the analysis result acquired by the analysis section 20 when only one analysis result is acquired by the analysis section 20.

In addition, the syntax analysis device 1 is constituted by a programmed computer and is realized by executing a syntax analysis program on the computer. The syntax analysis program includes steps corresponding to the respective sections of the syntax analysis device 1 shown in FIG. 1. That is, the program includes an input step for inputting a sentence of natural language, an analysis step for executing a morphological analysis and a syntax analysis with respect to the input sentence inputted in the input step, an extraction step for extracting the most similar analyzed corpus to the input sentence from an analyzed corpus database, a similarity calculation step for calculating the similarity between each analysis candidate and the extracted analyzed corpus when a plurality of analysis candidates are acquired in the analysis step, and an output step for outputting the analysis candidate with the maximum similarity as an analysis result when a plurality of analysis candidates are acquired in the analysis step or for outputting the analysis result acquired in the analysis step when only one analysis result is acquired in the analysis step.

The input section 10 is an input device such as a keyboard, an optical character reader, or a file reader that reads a sentence of the natural language as an analysis target from a text file. The inputted sentence is sent to the analysis section 20. The input of a sentence by the input section 10 corresponds to the above-mentioned input step.

The analysis section 20 is realized by executing the above-mentioned analysis step. The analysis section 20 includes a morphological analysis section 21 and a syntax analysis section 22. The morphological analysis section 21 divides a sentence into words (morphemes) according to the syntax rule and the statistics technique that are known as prior arts. The syntax analysis section 22 analyzes the structure of a sentence based on the analyzed morphemes. The morphological analysis section 21 has a function to presume an unregistered word contained in an input sentence on the basis of the knowledge about the natural language to be used (Chinese in the embodiment). When an input sentence in an isolated language such as Chinese contains an unknown word or an ambiguous compound noun, a plurality of analysis candidates may be acquired by the analysis section 20.

The analyzed-corpus database 30 stores a large number of sentences (analyzed corpus) that are correctly analyzed by the morphological analysis and the syntax analysis as records. Each record of the analyzed-corpus database 30 has three fields including a serial number field, a corpus field, and a syntactic structure field. For example, the records as shown in the following table 1 are registered.

TABLE 1

| Serial | | |
|---|---|---|
| number | Corpus | Syntactic structure |
| 1 | [symbol] | [symbol] |
| | | [symbol] |
| 2 | [symbol] | [symbol] |
| | | [symbol] |
| 3 | [symbol] | [symbol] |

An identification number of a corpus is stored in the “serial number” field, a sentence (a text, a clause) in the natural language is stored in the “corpus” field, and a correctly analyzed result of a corpus is stored in the “syntactic structure” field, respectively. The analyzed result stored in the “syntactic structure” field includes a case relation and a part of speech (shown by a symbol in Table 1) for each divided morpheme. Notational conventions in the “syntactic structure” field will be described. In the following description, “M” means a morpheme, “P” means a part of speech and “C” means a case relation. When a sentence has two morphemes, the syntactic structure is shown in the form of “(M/P C, M/P)”. When a sentence has three morphemes, it is shown in the nesting form of “(M/P, C, (M/P, C, M/C)”. The case relations include a nominative case, an objective case, a modifier, a parallel case or the like. The parts of speech include a noun (symbol: n), a pronoun (symbol: rn), a verb (symbol: v), an adjective (symbol: a), an adverb (symbol: ad), a preposition (symbol: p) or the like.

The extraction section 40 is realized by executing the above-mentioned extraction step. The extraction section 40 searches the analyzed-corpus database 30 and extracts the most similar analyzed corpus to the input sentence from many analyzed corpora registered in the database 30 by a method such as the vector space method.

The similarity calculation section 50 is realized by executing the above-mentioned similarity calculation step. The similarity calculation section 50 calculates the similarity between each of analysis candidates acquired by the analysis section 20 and the analyzed corpus using the contents of morphemes analyzed by the morphological analysis section 21 and the syntactic structure analyzed by the syntax analysis section 22. Specifically, the similarity calculation section 50 calculates the similarity S by the following equation.
S=(W₁/W) ·W2

In this equation, W denotes the number of morphemes in the analysis candidate, W₁ denotes the number of morphemes that have the same structure as morphemes of the extracted analyzed corpus, and W₂ denotes the number of morphemes that have the same structure and notation as morphemes of the extracted analyzed corpus. It can be judged that the similar degree becomes larger as the similarity S increases.

The output section 60 is realized by executing the above-mentioned output step. The output section 60 chooses the analysis candidate with the largest similarity S, which is calculated by the similarity calculation section 50, from a plurality of analysis candidates and outputs the chosen candidate as an analysis result when a plurality of analysis candidates are acquired by the analysis section 20. On the other hand, when only one analysis result is acquired by the analysis section 20, the output section 60 outputs the analysis result acquired by the analysis section 20. The analysis result is displayed on a screen, and/or printed on a paper, and/or written into a file.

Next, an operation of the syntax analysis device 1 of the embodiment will be described using concrete input sentences. The case where an input sentence 1 shown in Table 2 is inputted is described first. The input sentence 1 contains a problem of processing of an unregistered word. In this case, the analysis section 20 outputs two analysis candidates shown in Table 2. The descriptions of the case relations and parts of speech in the analyzed-corpus database 30 are also applicable to Table 2. However, the analysis section 20 treats an unregistered word as a part of speech. An unregistered word is indicated by a symbol “u”.

TABLE 2
Input sentence 1: [symbol] (Meanings: [symbol] sells a new TV set.)
Analysis candidate 1: [symbol]
Analysis candidate 2:

[symbol]

[symbol]

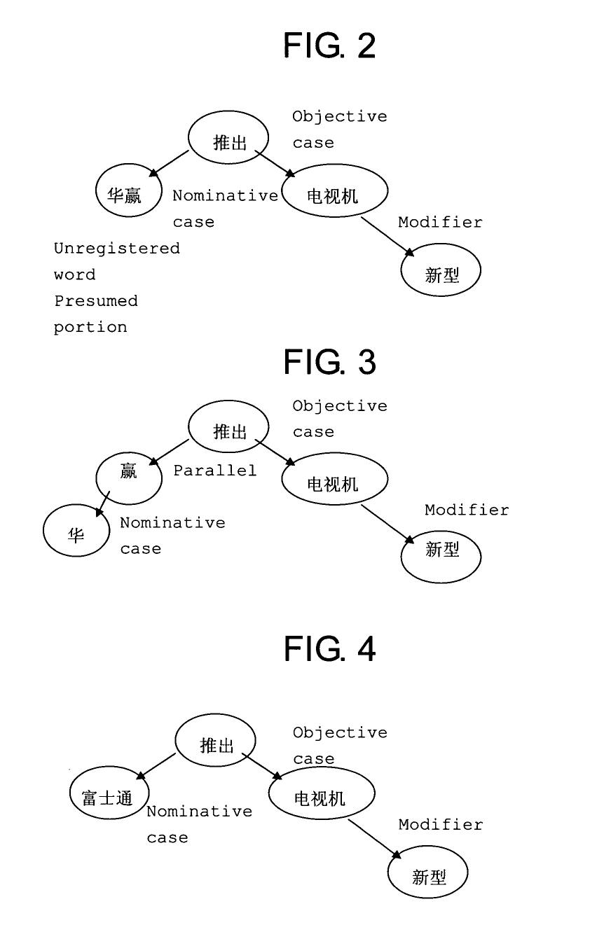

Structures of the analysis candidates 1 and 2 are shown in FIGS. 2 and 3, respectively. In the analysis candidate 1, the input sentence 1 is analyzed with assuming that the first and second characters of the input sentence 1 form the unregistered word of the nominative case on the basis of the knowledge about Chinese that the first character of the input sentence 1 hardly forms a noun independently. On the other hand, in the analysis candidate 2, the input sentence 1 is analyzed with assuming that the first character forms the noun of the nominative case and that the second character is a verb. Both of the candidates are common in the third and latter characters. That is, the third and fourth characters are analyzed as a verb and the fifth through ninth characters are analyzed as an objective case. The fifth and sixth characters are analyzed as a modifier and the seventh through ninth characters are analyzed as a modificand.

The extraction section 40 searches the analyzed-corpus database 30 and extracts a corpus that is similar to the above-mentioned input sentence 1. In this example, the analyzed corpus of serial number 1 of Table 1 is chosen. The structure of the corpus of serial number 1 is shown in FIG. 4.

Subsequently, the similarity calculation section 50 calculates the similarity between the corpus of serial number 1 extracted by extraction section 40 and each of the analysis candidates 1 and 2 analyzed by the analysis section 20. First, the similarity calculation section 50 calculates the similarity between the analysis candidate 1 shown in FIG. 2 and the analyzed corpus of serial number 1 shown in FIG. 4. In this example, the number of morphemes in the analysis candidate 1 equals 4 (W=4), the number of morphemes that have the same structure as morphemes of the extracted analyzed corpus equals 4 (W₁=4) , and the number of morphemes that have the same structure and notation as morphemes of the extracted analyzed corpus equals 3 (W₂=3). Accordingly, the following equation holds.
S=(W₁/W)·W₂=(4/4)·3=3

Next, the similarity calculation section 50 calculates the similarity between the analysis candidate 2 shown in FIG. 3 and the analyzed corpus of serial number 1 shown in FIG. 4. In this example, the number of morphemes in the analysis candidate 2 equals 5 (W=5), the number of morphemes that have the same structure as morphemes of the extracted analyzed corpus equals 3 (W₁=3), and the number of morphemes that have the same structure and notation as morphemes of the extracted analyzed corpus equals 3 (W₂=3). Accordingly, the following equation holds.
S=(W₁/W)·W₂=(3/5)·3=1.8

Since the similarity of the analysis candidate 1 becomes higher than that of the analysis candidate 2, the output section 60 outputs the analysis candidate 1 as the analysis result of the input sentence 1.

Next, the case where an input sentence 2 shown in Table 3 is inputted is described. The input sentence 2 contains a problem of delimitation of a compound noun. In this case, the analysis section 20 outputs two analysis candidates as shown in Table 3.

TABLE 3
Input sentence 2:

[symbol]

(Meaning: B company makes a game site.)

Analysis candidate 3: [symbol]
Analysis candidate 4:

[symbol]

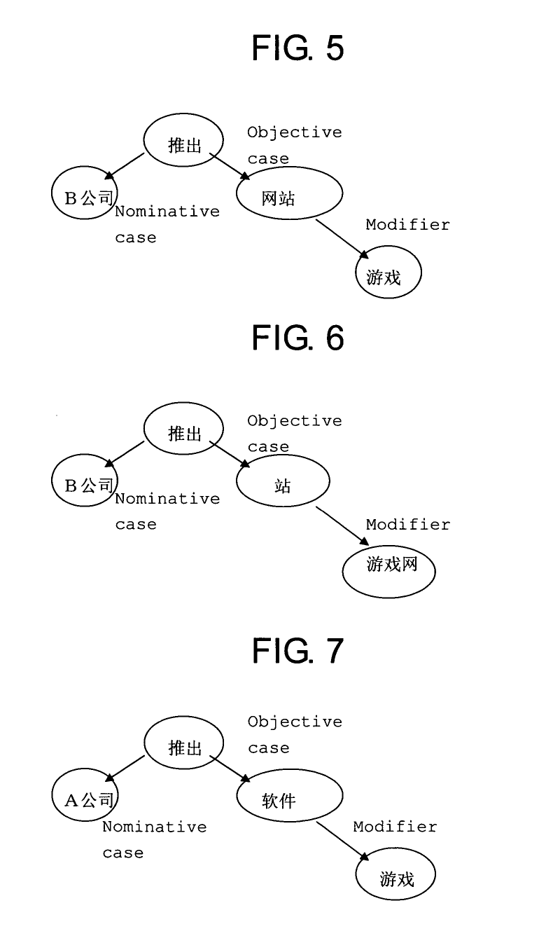

Structures of the analysis candidates 3 and 4 are shown in FIGS. 5 and 6, respectively. The first through fifth characters are analyzed in the same manner in both of the candidates. That is, the first through third characters form a noun of a nominative case and the fourth and fifth characters form a verb. The analysis candidate 3 is different from the analysis candidate 4 in analysis of the sixth through ninth characters. That is, in the analysis candidate 3, the sixth and seventh characters analyzed as a modificand noun and the eight and ninth characters are analyzed as a modifier noun. On the other hand, in the analysis candidate 4, the sixth through eighth characters are analyzed as a modificand noun and the ninth character is analyzed as a modifier noun.

The extraction section 40 searches the analyzed-corpus database 30 and extracts a corpus that is similar to the above-mentioned input sentence 2. In this example, the analyzed corpus of serial number 2 of Table 1 is chosen. The structure of the corpus of serial number 2 is shown in FIG. 7.

Subsequently, the similarity calculation section 50 calculates the similarity between the corpus of serial number 2 extracted by extraction section 40 and each of the analysis candidates 3 and 4 analyzed by the analysis section 20. First, the similarity calculation section 50 calculates the similarity between the analysis candidate 3 shown in FIG. 5 and the analyzed corpus of serial number 2 shown in FIG. 7. In this example, the number of morphemes in the analysis candidate 3 equals 4 (W=4), the number of morphemes that have the same structure as morphemes of the extracted analyzed corpus equals 4 (W₁=4), and the number of morphemes that have the same structure and notation as morphemes of the extracted analyzed corpus equals 2 (W₂=2). Accordingly, the following equation holds.
S=(W₁/W)·W₂₌(4/4)·2=2

Next, the similarity calculation section 50 calculates the similarity between the analysis candidate 4 shown in FIG. 6 and the analyzed corpus of serial number 2 shown in FIG. 7. In this example, the number of morphemes in the analysis candidate 4 equals 4 (W=4), the number of morphemes that have the same structure as morphemes of the extracted analyzed corpus equals 4 (W₁=4), and the number of morphemes that have the same structure and notation as morphemes of the extracted analyzed corpus equals 1 (W₂=1) Accordingly, the following equation holds.
S=(W₁/W)·W₂₌(4/4)·1=1

Since the similarity of the analysis candidate 3 becomes higher than that of the analysis candidate 4, the output section 60 outputs the analysis candidate 3 as the analysis result of the input sentence 2.

Although the calculation section 50 calculates the similarity by comparing the structures and the contents of the morphemes in the above-mentioned example, the similarity can be also calculated using a thesaurus. Calculation of the similarity using a thesaurus is described below.

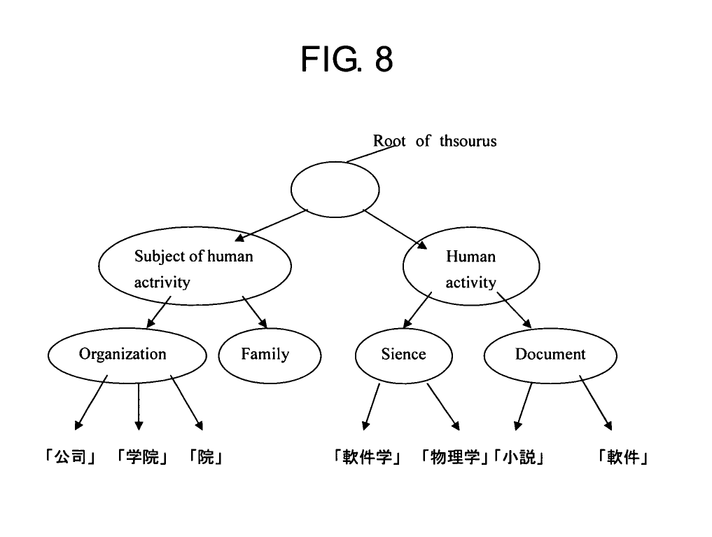

For example, a thesaurus as shown in FIG. 8 is prepared. A phrase surrounded with the ellipse is a concept and a phrase enclosed in the parenthesis is a concrete content. A similarity between contents of morphemes acquired by analyzing an input sentence and contents of morphemes of an extracted analyzed corpus is calculated as a correlation degree between concepts in the thesaurus. Specifically, the correlation degree (Wi, Wj) between words “Wi and Wj” is calculated by (Wi, Wj)=1/2ⁿ (n=0, 1, 2, - - - ).

The symbol “n” is a distance between concepts.

A distance between words belonging to the same concept is 0. A distance between words belonging to different concepts is calculated by adding the steps from one word to the common generic concept to the steps from the other word to the common generic concept.

For example, since the distance between [symbol] and [symbol] is 0, a correlation degree (Wi, Wj)= [symbol] =1/2⁰ =1. Further, since the distance between [symbol] and [symbol] is 2, a correlation degree (Wi, Wj)= [symbol] =1/2²=1/4.

A correlation degree is calculated for each and every morphemes and the total amount Σ (Wi, Wj) is used as a correlation degree of the whole sentence.

It can be judged that the correlation degree becomes larger as the similarity increases.

The example of a similarity calculation using the thesaurus when input sentence 3 shown in Table 4 is inputted will be described. The input sentence 3 contains a problem of delimitation of a compound noun. When the input sentence 3 is inputted, the analysis section 20 outputs two analysis candidates 5 and 6 as show in Table 4.

TABLE 4
Input sentence 3: [symbol] (Meanings: This is a software school.)
Analysis candidate 5: [symbol]
Analysis candidate 6:

[symbol]

The analysis candidates 5 and 6 are identical in the analysis of a nominative. However, they are different to each other in the analysis of the third through sixth characters. That is, in analysis candidate 5, the third and fourth characters are analyzed as a modificand noun and the fifth and sixth characters are analyzed as a modifier noun. On the other hand, in analysis candidate 6, the third through fifth characters are analyzed as a modificand noun and the sixth character is analyzed as a modifier noun.

The extraction section 40 searches the analyzed-corpus database 30 and extracts a corpus that is similar to the above-mentioned input sentence 3. In this example, the analyzed corpus of serial number 3 of Table 1 is chosen.

Subsequently, the similarity calculation section 50 calculates the similarity between the corpus of serial number 3 extracted by extraction section 40 and each of the analysis candidates 5 and 6 analyzed by the analysis section 20. Here, the calculation of the correlation degree about the portion with common analysis is omitted and the calculation of the correlation degree about the third through sixth characters will be described. The correlation degrees between the respective morphemes are shown in the upper area in the following Table 5. The correlation degrees of the respective candidates are shown in the middle area and the lower area in Table 5.

TABLE 5 [symbol]
= ½⁰ = 1 [symbol]
= ½² = ¼ [symbol]
= ½⁰ = 1 [symbol]
= ½⁰ = 1
Similarity of analysis candidate 5 = [symbol] = 1 + 1 = 2
Similarity of analysis candidate 6 =

[symbol]

Since the similarity of the analysis candidate 5 becomes higher than that of the analysis candidate 6, the output section 60 outputs the analysis candidate 5 as the analysis result of the input sentence 3.

Since the syntax analysis device 1 of the above-mentioned embodiment compares the analysis candidates of the input sentence with the extracted corpus using the analyzed-corpus database 30 and outputs the analysis candidate having higher similarity, an accurate analysis can be executed even when the input sentence contains an unregistered word or an ambiguous compound noun. Accordingly, the use of the device 1 at a step prior to translation can decrease the possibility of mistranslation.

Although the calculation of the similarity using structures and contents of morphemes and the calculation of the correlation degree of contents of morphemes using thesaurus are independently described in the above-described embodiment, these two approaches can be applied at the same time in order to judge the similarity in the comprehensive manner.

What is claimed is:

1. A syntax analysis program that makes a computer execute steps comprising:
an input step for inputting a sentence of a natural language;
an analysis step for executing a morphological analysis and a syntax analysis with respect to the input sentence inputted in said input step;
an extract ion step for extracting the most similar analyzed corpus to the input sentence from an analyzed corpus database;
a similarity calculation step for calculating the similarity between each analysis candidate and the extracted analyzed corpus when a plurality of analysis candidates are acquired in said analysis step, and
an output step for outputting the analysis candidate with the maximum similarity as an analysis result when a plurality of analysis candidates are acquired in said analysis step or for outputting the analysis result acquired in said analysis step when only one analysis result is acquired in said analysis step.

2. The syntax analysis program according to claim 1, wherein said analysis step has a function to presume an unregistered word contained in an input sentence based on the knowledge about the natural language to be used.

3. The syntax analysis program according to claim 1, wherein the similarity between an analytical candidate and an analyzed corpus can be calculated using the contents of the morphemes analyzed by the morphological analysis and the syntax structure analyzed by the syntax analysis in said similarity calculation step.

4. The syntax analysis program according to claim 3, wherein the similarity S can be calculated by the following equation in said similarity calculation step:
S=(W₁/W)·W₂
where W denotes the number of morphemes in the analysis candidate, W₁ denotes the number of morphemes that have the same structure as morphemes of the extracted analyzed corpus, and W₂ denotes the number of morphemes that have the same structure and notation as morphemes of the extracted analyzed corpus.

5. The syntax analysis program according to claim 1, wherein the similarity between the contents of the morphemes analyzed by the morphological analysis and the contents of the morpheme of the analyzed corpus is calculated as a correlation value between the concepts by a thesaurus in said similarity calculation step.

6. A syntax analysis method that analyzes syntax with a programmed computer, said method comprising:
an input step for inputting a sentence of a natural language;
an analysis step for executing a morphological analysis and a syntax analysis with respect to the input sentence inputted in said input step;
an extraction step for extracting the most similar analyzed corpus to the input sentence from an analyzed corpus database;
a similarity calculation step for calculating the similarity between each analysis candidate and the extracted analyzed corpus when a plurality of analysis candidates are acquired in said analysis step, and
an output step for outputting the analysis candidate with the maximum similarity as an analysis result when a plurality of analysis candidates are acquired in said analysis step or for outputting the analysis result acquired in said analysis step when only one analysis result is acquired in said analysis step.

7. A syntax analysis device that analyzes syntax with a programmed computer, said device comprising:
an input section for inputting a sentence of a natural language;
an analysis section for executing a morphological analysis and a syntax analysis with respect to the input sentence inputted in said input section;
an extract ion section for extracting the most similar analyzed corpus to the input sentence from an analyzed corpus database;
a similarity calculation section for calculating the similarity between each analysis candidate and the extracted analyzed corpus when a plurality of analysis candidates are acquired in said analysis section, and
an output section for outputting the analysis candidate with the maximum similarity as an analysis result when a plurality of analysis candidates are acquired in said analysis section or for outputting the analysis result acquired in said analysis section when only one analysis result is acquired in said analysis section.

8. A computer-readable medium storing a syntax analysis program that makes a computer execute steps comprising:
an input step for inputting a sentence of a natural language;
an analysis step for executing a morphological analysis and a syntax analysis with respect to the input sentence inputted in said input step;
an extraction step for extracting the most similar analyzed corpus to the input sentence from an analyzed corpus database;
a similarity calculation step for calculating the similarity between each analysis candidate and the extracted analyzed corpus when a plurality of analysis candidates are acquired in said analysis step, and
an output step for outputting the analysis candidate with the maximum similarity as an analysis result when a plurality of analysis candidates are acquired in said analysis step or for outputting the analysis result acquired in said analysis step when only one analysis result is acquired in said analysis step.
